(19) United States
(12) Patent Application Publication
(10) Pub. No.: US 2017/0001917 A1
(43) Pub. Date: Jan. 5, 2017

(54) HIGH DENSITY CARBON-CARBON FRICTION MATERIALS

(71) Applicant: Honeywell International Inc., Morristown, NJ (US)

(72) Inventors: Mark L. La Forest, Granger, IN (US); Mark E. Behnke, South Bend, IN (US); Neil Murdie, Granger, IN (US); Slawomir T. Fryska, Granger, IN (US)

(21) Appl. No.: 14/788,336

(22) Filed: Jun. 30, 2015

(51) Int. Cl. C04B 35/83; C04B 35/52

(52) U.S. Cl. CPC C04B 35/83; C04B 35/521

(57) ABSTRACT

A method for making a carbon-carbon composite brake disc by infiltrating a porous carbon preform with a resin and carbonizing the resin-infiltrated preform at a high pressure of at least about 5,000 psi to form a densified carbon-carbon composite disc brake with a final density of at least about 1.9 g/cc. The porous carbon preform includes a plurality of fabric sheets having non-woven oxidized polyacrylonitrile fibers, pitch fibers, or rayon fibers and a basis weight in the range from about 1250 to about 3000 grams per square meter. The fabric sheets are needled together. The porous carbon preform is infiltrated with resin, which includes at least one of an isotropic resin or a mesophase resin.

### TECHNICAL FIELD

The disclosure relates to the manufacture of carbon-carbon composite materials, and especially to the manufacture of aircraft brake discs made of carbon-carbon composite materials.

### BACKGROUND

Carbon fiber-reinforced carbon materials, also referred to as carbon-carbon composite materials, are composite materials that include a matrix including carbon reinforced with carbon fibers. The carbon-carbon (C—C) composite components can be used in many high temperature applications. For example, the aerospace industry employs C—C composite components as friction materials for commercial and military aircraft, such as brake friction materials.

Some carbon-carbon composite bodies, such as some carbon-carbon composite brake discs that are used in the aerospace industry, may be manufactured from porous preforms. The preforms may be densified using a combination of several processes, including chemical vapor deposition/chemical vapor infiltration (CVD/CVI), vacuum/pressure infiltration (VPI), or resin transfer molding (RTM), which may apply carbon within the porous preform. CVD/CVI processing is an expensive, capital intensive and is a time-consuming process, frequently taking several months to complete. In some examples the cycle time and costs associated with CVD/CVI processing may be reduced by using VPI or RTM processes in combination with CVI/CVD. VPI and RTM processes, however, may require several cycles over a prolonged period of time resulting in final densities of less than 1.75 g/cc.

### SUMMARY

In some examples, the disclosure describes a method for making a carbon-carbon composite brake disc, including: (i) infiltrating a porous preform with a resin to form a resin-infiltrated preform, where the resin includes at least one of an isotropic resin or a mesophase resin, and where the porous preform is derived from a plurality of fabric sheets including non-woven fibers selected from the group consisting of oxidized polyacrylonitrile fibers, pitch fibers, or rayon fibers, where each fabric sheet of the plurality of fabric sheets has a basis weight in the range from about 1250 to about 3000 grams per square meter, and needling fibers selected from the group consisting of oxidized polyacrylonitrile fibers, pitch fibers, or rayon fibers, wherein the needling fibers join together the plurality of fabric sheets. The method also may include (ii) carbonizing the resin-infiltrated preform at a pressure of at least about 5,000 psi to form a densified carbon-carbon composite disc brake. Further, the method may include (iii) repeating steps (i)-(ii) until the densified carbon-carbon composite disc brake has a density of at least about 1.9 g/cc.

In some examples, the disclosure describes a method for making a carbon-carbon composite brake disc, which includes (i) placing a porous preform in a high pressure vessel, where the porous preform is derived from a plurality of fabric sheets including non-woven fibers selected from the group consisting of oxidized polyacrylonitrile fibers, pitch fibers, or rayon fibers, where each fabric sheet of the plurality of fabric sheets has a basis weight in the range from about 1250 to about 3000 grams per square meter, and needling fibers selected from the group consisting of oxidized polyacrylonitrile fibers, pitch fibers, or rayon fibers, where the needling fibers join together the plurality of fabric sheets. The method also may include (ii) infiltrating, in the high pressure vessel, the porous preform with a resin using a first pressure of at least about 50 psi to form a resin-infiltrated preform, where the resin comprises at least one of an isotropic resin or a mesophase resin. The method additionally may include (iii) carbonizing the resin-infiltrated preform under a second high pressure of at least about 5,000 psi, to form a densified carbon-carbon composite disc brake.

In some examples, the disclosure describes an assembly for making a carbon-carbon composite disc brake including a high pressure vessel and a resin-infiltrated preform in the shape of a disc brake including a non-stabilized resin including at least one of an isotropic resin or a mesophase resin, and a porous preform derived from a plurality of fabric sheets comprising non-woven fibers selected from the group consisting of oxidized polyacrylonitrile fibers, pitch fibers, or rayon fibers, where each fabric sheet of the plurality of fabric sheets has a basis weight in the range from about 1250 to about 3000 grams per square meter, and needling fibers selected from the group consisting of oxidized polyacrylonitrile fibers, pitch fibers, or rayon fibers, where the needling fibers join together the plurality of fabric sheets, and where the resin-infiltrated preform is disposed in the high pressure vessel. The assembly also may include a pressure source configured to pressurize the high pressure vessel to a pressure of at least about 5,000 psi and a heat source configured to heat the high pressure vessel and resin-infiltrated preform to a temperature sufficient to carbonize the non-stabilized resin.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a flow diagram illustrating an example method of manufacturing a densified carbon-carbon composite from a porous preform.

FIG. 2 is a perspective view of an example porous carbon preform that may be used to manufacture a densified carbon-carbon composite.

FIG. 3 is an enlargement of section A from FIG. 2.

FIG. 4 illustrates a lateral cross-sectional view of an example mold containing a porous carbon preform.

FIG. 5 is a perspective view of an example densified carbon-carbon composite.

FIG. 6 illustrates a lateral cross-sectional view of an example mold enclosing a porous carbon preform.

### DETAILED DESCRIPTION

The present disclosure describes a low cost and time efficient method to produce a densified carbon-carbon (C—C) composite in the form of a disc brake with a density of at least about 1.9 grams per cubic centimeter (g/cc). The density of at least about 1.9 g/cc may possess mechanical and thermal properties, including friction and wear performance, that are improved compared to lower density C—C composites. For example, obtaining a higher densify in the carbon-carbon composite may improve the thermal conductivity of the composite or may provide enhanced structural strength. Densified C—C composite disc brakes possessing improved densities in accordance with the disclosure may be useful in a variety of applications including, for example, use in the aerospace industry.

The densified C—C composite manufacturing methods described in this disclosure utilize non-woven preforms with an areal basis weight of about 1250 to about 3000 grams per square meter (g/m²) and a high pressure carbonization of infiltrated pitch to obtain a densified C—C composite having overall density greater than 1.9 g/cc. In some examples, densified C—C composite manufacturing methods described in this disclosure may omit CVD/CVI densification steps, resin stabilization, or both, while simultaneously being able to obtain a densified C—C composite having overall density greater than 1.9 g/cc. CVD/CVI processing is a relatively slow and expensive process requiring significant capital investment to implement. Furthermore, a single cycle of CVD/CVI generally provides only an incremental increase in the overall density of preform, thus requiring several cycles of CVD/CVI to obtain C—C composites having increased densities. Other preforms may be subjected to resin densification cycles using either vacuum pressure infiltration (VPI) or resin transfer molding (RTM). VPI and RTM involve depositing a molten resin on the surface of the porous preform while subjecting the preform to a pressure differential that either draws (e.g., vacuum pressure of VPI) or forces (e.g., head pressure of RTM) the molten resin into the open pores of the preform.

Once the resin sufficiently infiltrates the preform, the resin-infiltrated preform is cooled to allow the resin to solidify within the preform. Next the resin-infiltrated preform undergoes a resin stabilization cycle, which allows the resin to undergo some degree of crosslinking, thereby inhibiting the resin from leeching out of the preform during the subsequent carbonization process, which is conducted above the melting point of the resin. However, the resin stabilization cycle can be extremely time intensive, requiring several months for the resin to undergo sufficient crosslinking, and even with resin stabilization, some amount of resin may be forced out of the preform during carbonization because of gases evolved from the resin as it is converted to char. In contrast to CVD/CVI, and techniques including resin stabilization, by utilizing the preforms described herein and carbonization of an infiltrated resin while exerting a high pressure may reduce manufacturing time and cost while still providing a high density (e.g., greater than about 1.90 g/cc) carbon-carbon composite material.

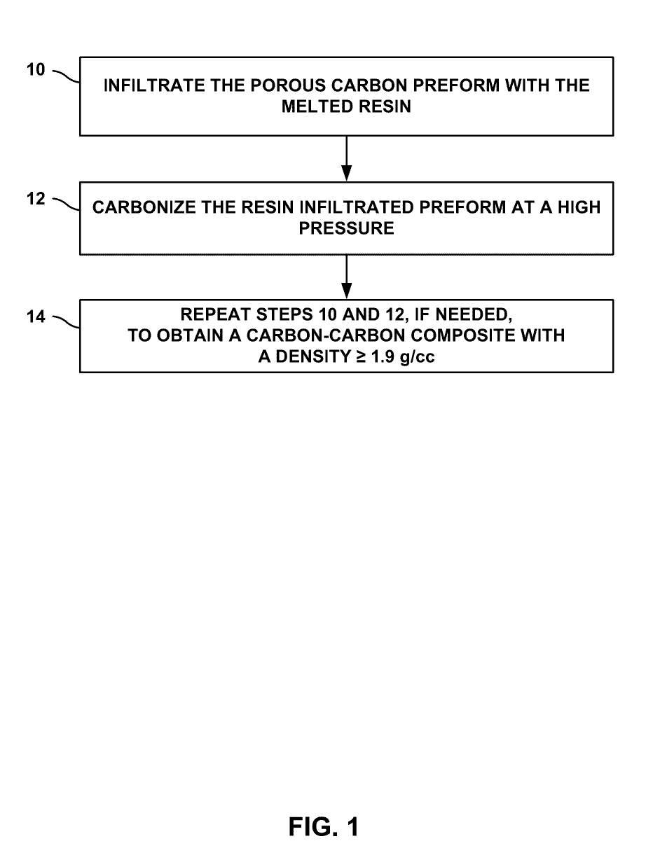

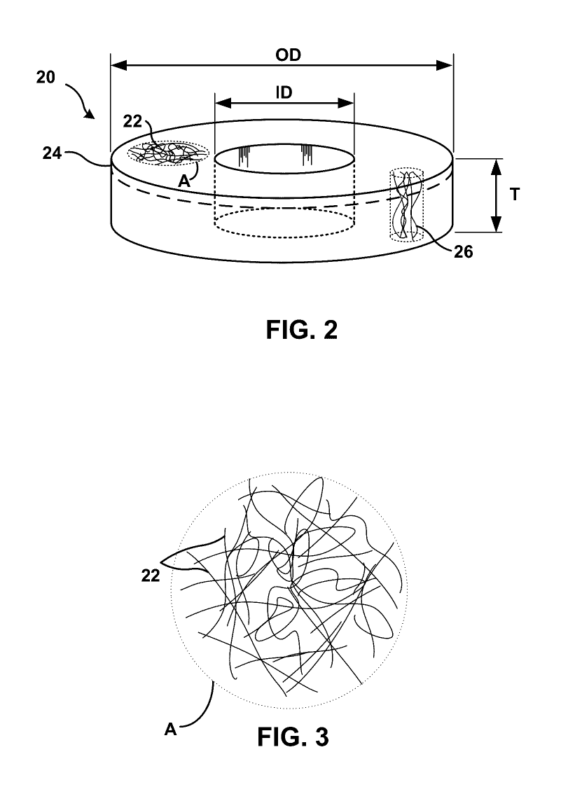

FIG. 1 is a flow diagram illustrating an example technique of manufacturing a densified carbon-carbon composite from a porous carbon preform. For ease of illustration, the example method of FIG. 1 is described with respect to the articles and systems of FIGS. 2-5; however, other articles and systems for manufacturing densified carbon-carbon composite are also contemplated by this disclosure.

The example technique of FIG. 1 includes infiltrating a porous carbon preform with a molten resin (10) and carbonizing the resin-infiltrated preform while under the high pressure without subjecting the resin to a resin stabilization cycle prior to carbonization (12). In some examples, the above steps may be repeated if needed to obtain densified C—C composite having a final density of at least 1.9 g/cc (14).

The first step of the example technique of FIG. 1 includes infiltrating a porous carbon preform with a molten resin (10). FIG. 2 illustrates an example precursor preform 20 that may be used to form the porous carbon preform used in the technique of FIG. 1. Precursor preform 20 may include non-woven fabric sheets 24 containing high areal weight fibers 22 of oxidized polyacrylonitrile (O-PAN), rayon, or pitch. By way of example, FIG. 3 shows an enlargement of the portion A from FIG. 2, illustrating individual fibers 22 combined together to form non-woven fabric sheet 24. In some examples, the fabric sheets 24 may be formed to have an areal basis weight between about 1250 and about 3000 grams per square meter (g/m²) such as, between about 1350 and about 2000 g/m².

Forming precursor preform 20 using non-woven fabric sheets 24 including fibers 22, e.g., O-PAN fibers, may increase the areal weight of non-woven fabric sheets 24, while maintaining an open pore construction which ultimately reduces material and operational costs. These benefits are achieved, at least in part, because non-woven fabric sheets 24 with a higher areal basis weight may require less needling to bind the fabric sheets 24 together while also establishing a more open preform with wider and deeper pores which are more easily infiltrated with the molten resin compared to preforms with smaller or narrower pores (10), without substantially reducing the density of precursor preform 20 compared to fabrics with a lower areal basis weight.

The individual non-woven fabric sheets 24 may be needled together using loose fibers 26 similar to fibers 22 used to make fabric sheets 24. In some examples, loose fibers 26 may be needled through multiple layers of non-woven fabric sheets 24 using, for example, a rotating annular needler or a non-rotating annular needler. In the case of annular needler, precursor preform 20 may be formed by needling two layers of non-woven fabric sheets 24 together and then needling additional non-woven fabric sheets 24 on top of the previously needled layers. In some examples, the annular needler may have a needle stroke rate of about 700 strokes per minute or more (for instance, a stroke speed between about 850 and about 1250 strokes/min) and a rotational bowl speed of about 2 rpm. In some examples, the needling time may be reduced by increasing the bowl rotation speed, e.g., 3 rpm, while keeping the ratio of strokes per rotation at about 350 strokes per rotation. When using an annular needler, the first layer of non-woven fabric sheet 24 may be placed on a pliable material, such as a foam ring, with a subsequent non-woven fabric sheet 24 placed one on top of the first layer to allow the needles and loose fibers 26 to penetrate all the way through the two non-woven fabric sheets 24 without damaging the needles. Needling of non-woven fabric sheets 24 may be continued until precursor preform 20 reaches the target thickness T. Tables 1 and 2 below provide examples of porous carbon preforms 20 envisioned for use with the method illustrated in FIG. 1.

In some examples, precursor preform 20 may be subjected to an initial carbonization cycle to convert the carbon fiber-precursor material to carbon, prior to being infiltrated with resin 40 (10). For example, precursor preform 20 may be carbonized by heating precursor preform 20 in a retort under inert or reducing conditions to remove the non-carbon constituents (hydrogen, nitrogen, oxygen, etc.) from high areal weight fibers 22 and loose fibers 26. Initially carbonizing precursor preform 20 produces a porous carbon preform of carbon fibers. The carbonization can be carried out using retort, such as an autoclave, a furnace, a hot isostatic press, a uniaxial hot press, or the like. In each of these techniques, precursor preform 20 may be heated in the inert atmosphere at a temperature in the range of about 600° to about 1000° C. while optionally being mechanically compressed. The mechanical compression may be used to define the geometry (e.g., thickness) of the porous carbon preform and the volume fraction of carbon in the porous carbon preform (e.g., the volume of carbon divided by the total, bulk volume of the porous carbon preform). In some examples, the retort may be purged gently with nitrogen for approximately 1 hour, then slowly heated to about 900° C. over the course of approximately 10-20 hours, followed by elevating the temperature to about 1050° C. over approximately 1-2 hours. The retort then may be held at about 1050° C. for approximately 3-6 hours before the carbonized preform is allowed to cool overnight. In some examples, the carbonization step can be carried out at even higher temperature, including up to about 1800° C.

In some examples, after carbonization of precursor preform 20, the resultant porous carbon preform may also be heat treated prior to undergoing the resin infiltration cycle (10). Heat treating the porous carbon preform may modify the crystal structure of the carbon atoms in the porous carbon preform, which may result in modified mechanical, thermal, and chemical properties of the preform or composite respectively. In some examples, heat treatment of the porous carbon preform may be conducted in the range of 1400° C. to 2800° C., depending on the desired characteristics. Higher temperatures may result in a greater thermal conductivity, a greater degree of crystalline order of the carbon atoms in the resultant porous carbon preform, and may increase the elastic modulus of the final C—C composite. The degree of crystalline order may be determined using, for example, X-ray diffraction or Raman spectroscopy.

As used herein, a porous carbon preform derived from fabric sheets 24 is intended to describe a carbon fiber perform that is formed by carbonizing precursor preform 20.

TABLE 1

| Process Step | Rotating Annular Baseline | Rotating Annular Ex. 1 | Rotating Annular Ex. 2 |
|---|---|---|---|
| Fiber Type | O-PAN | O-PAN | O-PAN |
| Fabric Composition | 85% Continuous Tow | 75% Continuous Tow | 85% Continuous Tow |
| | 15% Staple | 25% Staple | 15% Staple |
| Fabric Weight | 1000 grams/square meter | 1250 grams/square meter | 1500 grams/square meter |
| Fabric Type | Needle punched nonwoven | Needle punched nonwoven | Needle punched nonwoven |
| Segment Dimensions | Inside Radius: 6 inches | Inside Radius: 6 inches | Inside Radius: 6 inches |
| | Outside Radius: 12 inches | Outside Radius: 12 inches | Outside Radius: 12 inches |
| | Arc: 68 degrees | Arc: 68 degrees | Arc: 68 degrees |
| Needier Settings | Bowl Rotation: 2 rpm | Bowl Rotation: 2 rpm | Bowl Rotation: 2 rpm |
| | Needier Stroke: 700 spm | Needier Stroke: 700 spm | Needier Stroke: 700 spm |
| | Ratio: 350:1 | Ratio: 350:1 | Ratio: 350 to 1 |
| O-PAN Preform | Preform Wt: 6350 grams | Preform Wt: 6350 grams | Preform Wt: 6350 grams |
| | Preform Thk: 1.900 inches | Preform Thk: 1.900 inches | Preform Thk: 1.900 inches |
| Needling Time (minutes) | Needling Time: 15 minutes | Needling Time: 12 minutes | Needling Time: 10 minutes |
| Carbonization Temp. | 1650° C. | 1650° C. | 1650° C. |
| Carbonized Preform | Preform Wt: 2950 grams | Preform Wt: 2950 grams | Preform Wt: 2950 grams |
| | Preform Thk: 1.400 inches | Preform Thk: 1.400 inches | Preform Thk: 1.400 inches |

TABLE 2

| Process Step | Rotating Annular Baseline | Rotating Annular Ex. 3 | Rotating Annular Ex. 4 |
|---|---|---|---|
| Fiber Type | O-PAN | O-PAN | O-PAN |
| Fabric Composition | 85% Continuous Tow | 75% Continuous Tow | 85% Continuous Tow |
| | 15% Staple | 25% Staple | 15% Staple |
| Fabric Weight | 1000 grams/square meter | 1750 grams/square meter | 2000 grams/square meter |
| Fabric Type | Needle punched nonwoven | Needle punched nonwoven | Needle punched nonwoven |
| Segment Dimensions | Inside Radius: 6 inches | Inside Radius: 6 inches | Inside Radius: 6 inches |
| | Outside Radius: 12 inches | Outside Radius: 12 inches | Outside Radius: 12 inches |
| | Arc: 68 degrees | Arc: 68 degrees | Arc: 68 degrees |
| Needier Settings | Bowl Rotation: 2 rpm | Bowl Rotation: 2 rpm | Bowl Rotation: 2 rpm |
| | Needier Stroke: 700 spm | Needier Stroke: 700 spm | Needier Stroke: 700 spm |
| | Ratio: 350:1 | Ratio: 350 to 1 | Ratio: 350 to 1 |
| O-PAN Preform | Preform Wt: 6350 grams | Preform Wt: 6350 grams | Preform Wt: 6350 grams |
| | Preform Thk: 1.900 inches | Preform Thk: 1.900 inches | Preform Thk: 1.900 inches |
| Needling Time (minutes) | Needling Time: 15 minutes | Needling Time: 9 minutes | Needling Time: 8 minutes |
| Carbonization Temp. | 1650° C. | 1650° C. | 1650° C. |
| Carbonized Preform | Preform Wt: 2950 grams | Preform Wt: 2950 grams | Preform Wt: 2950 grams |
| | Preform Thk: 1.400 inches | Preform Thk: 1.400 inches | Preform Thk: 1.400 inches |

Using a precursor preform 20 as describe above may provide additional benefits during subsequent processing. For example, the carbonized form of precursor preform 20 may be sufficiently rigid so that an initial densification cycle of CVD/CVI is not necessary to protect the preform from damage, e.g., delamination, resulting from rapid infiltration of resin.

Example resins that can be used to infiltrate the porous carbon preform (10) include, for example, liquid resin or pitches (e.g., isotropic and/or mesophase pitches) that provide a relatively high carbon yield, e.g., of greater than about 80%, and may have a relatively high viscosity, such as synthetic mesophase pitches, coal-tar derived pitches, such as thermally or chemically treated coal tar, petroleum-derived pitches, synthetic-pitch derivatives, thermally treated pitches, catalytically converted pitches, and thermoset or thermoplastic resins, such as phenolic resins. An example of a synthetic mesophase pitch that may be used in the describe process includes an aromatic resin (AR) mesophase pitch made by Mitsubishi Gas Chemical Company, Inc. (Tokyo, Japan) or a catalytically polymerized naphthalene. In some examples, the resin may be an isotropic pitch including, for example, low cost coal tar pitches or petroleum pitches, a synthetic isotropic pitch, or the like. In addition to being lower cost, the disclosed techniques may also allow for greater conversion (e.g., higher carbon yield) of the isotropic resin to coke material, resulting in a more efficient process compared to carbonization at ambient pressures.

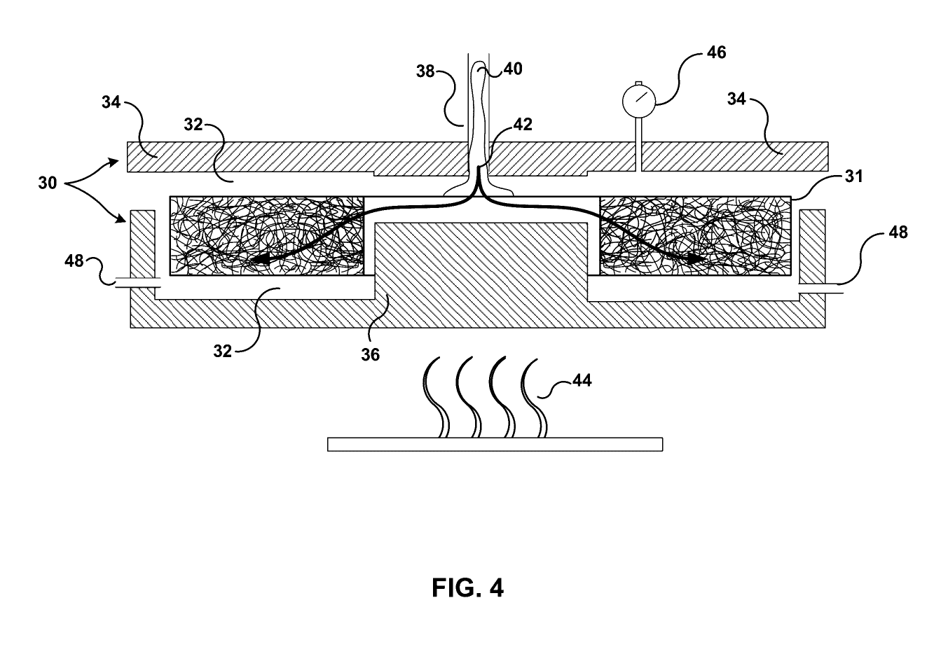

Infiltrating the porous carbon preform with molten resin (10) may be conducted using a number of techniques. For example, molten resin may be infiltrated into porous carbon preform (10) using VPI. Is such examples, porous carbon preform 31 may be placed in a mold 30, as shown in FIG. 4, which illustrates a lateral cross-sectional view of a mold 30 containing porous carbon preform 31. Mold 30 may include an upper mold portion 34 and a lower mold portion 36, which define an inner mold chamber 32 for receiving porous carbon preform 31. The upper and lower mold portions 34 and 36 may be configured to form a tight seal. Once porous carbon preform 31 is sealed within mold 30, porous carbon preform 31 is heated 44 under inert conditions to above the melting point of the resin to be infiltrated. Next, the gas contained in the pores of porous carbon preform 31 is removed by evacuating mold chamber 32. Molten resin 40 is then introduced into mold chamber 32, infiltrating porous carbon preform 31 as shown by flow lines 42 as the mold chamber is returned to ambient pressure. In some VPI processes, a volume of molten resin 40 may be melted in a different vessel and introduced into mold 30 via a resin inlet port 38.

In some examples, molten resin 40 may be infiltrated into porous carbon preform 31 (10) using RTM. In an RTM process, porous carbon preform 31 is placed and sealed inside mold chamber 32. Molten resin 40 may then be injected into mold chamber 32 through one or more resin inlet ports 38 under a head pressure that forces molten resin 40 into the inner pores of porous carbon preform 31. In some examples, mold 30 includes one or more vents 48 to allow gas (e.g., air) in mold chamber 32 and porous carbon preform 31 to escape as molten resin 40 is introduced into porous carbon preform 31.

In some examples, molten resin 40 may be infiltrated into porous carbon preform 31 (10) by depositing the resin in mold chamber 32 or directly on porous carbon preform 31. Once upper mold portion 34 and lower mold portion 36 are closed and sealed, the resin may be converted to a molten state, if needed, and the mold chamber may be pressurized using an inert gas 46, thereby forcing molten resin 40 into the inner pores of porous carbon preform 31 (10). In such examples, the initial pressure to facilitate infiltration of molten resin 40 may be about 50 psi to about 1,250 psi.

While FIG. 4 depicts pressure mold 30 having only a single chamber 32 that is provided for a single porous carbon preform 31, in other examples, mold 30 may be configured with a mold chamber 32 capable of holding a plurality of preforms. Alternatively, mold 30 may be configured with a plurality of chambers each holding one or more porous carbon preforms so that the plurality of preforms may be densified using the describe resin densifying process.

Once molten resin 40 has infiltrated porous carbon preform 31 (10), molten resin 40 may be carbonized at a high pressure (12). Performing the resin carbonization step at a high pressure (12) may in some examples lead to a more efficient densification process. For example, porous carbon preform 31 infiltrated with molten resin 40 may be carbonized at a high pressure without needing to first subject the resin-infiltrated preform to an extended resin-stabilization cycle. Instead, the high pressure forces applied to the porous carbon preform 31 infiltrated with molten resin 40 may help reduce or substantially prevent (e.g., nearly prevent or fully prevent) molten resin 40 from seeping out of porous carbon preform 31 as the temperature of molten resin 40 is increased to the point of carbonization, e.g., above 650° C.

Additionally or alternatively, in some examples, the high pressure applied to the porous carbon preform 31 infiltrated with molten resin 40 suppresses the formation of unwanted voids within molten resin 40 and porous carbon preform 31 that would otherwise form as a result of gases evolving from molten resin 40 as molten resin 40 is converted to char. The suppression of the voids within molten resin 40 and porous carbon preform 31 also helps retain resin 40 in porous carbon preform 31, as the evolution of gas may otherwise force some of molten resin 40 out of porous carbon preform 31 as molten resin 40 carbonizes.

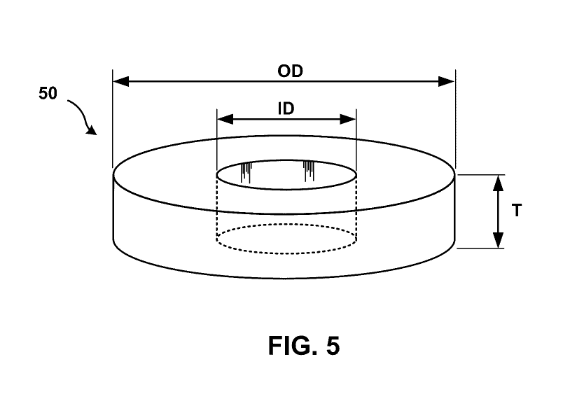

In this way, carbonizing molten resin 40 at a high pressure (12) may allow for greater retention and conversion to carbon of molten resin 40 within porous carbon preform 31, thereby resulting in a densified C—C composite 50 as shown in FIG. 5 with an overall density greater than what may be produced using conventional resin-stabilization and carbonization techniques. Further, by omitting resin-stabilization, the manufacturing time used to form densified C—C composite 50 may be reduced.

In some examples, carbonizing porous carbon preform 31 infiltrated with molten resin 40 at a high pressure (12) may be performed by pressurizing the mold chamber 32 using an inert gas 46. For example, if the resin is not already in a molten state, heat 44 may be applied to mold 30 to gradually raise the temperature of the resin and porous carbon preform 31 to above the melting point of resin, e.g., increasing the temperature to about 90 to 240° C. (depending on the type of resin) over about 0.5 to about 1.5 hours. Once the resin is converted into a molten state (e.g., molten resin 40), the internal pressure of mold chamber 32 may be increased to at least about 5,000 psi by, for example, introducing an inert gas 46 such as nitrogen, argon, carbon dioxide, or the like into mold chamber 32 to establish a high pressure environment around porous carbon preform 31.

Next, the temperature porous carbon preform 31 and molten resin 40 can be gradually increased to above the carbonization temperature of molten resin 40, e.g. above 650° C., while maintaining the internal pressure of mold chamber 32 at or above about 5,000 psi. In some examples, the temperature may be increased at a rate of between about 50 and about 150° C. per hour to a target temperature of about 650° C. with a target pressure of at least about 5,000 psi (e.g., about 10,000 to about 15,000 psi).

Once the target temperature and target pressure have been reached, the target temperature and target pressure are maintained sufficiently long to allow the infiltrated molten resin 40 to undergo carbonization (12). In some examples, mold 30 may be maintained at about 650° C. and about 10,000 to about 15,000 psi for about 1 to about 6 hours to obtain sufficient carbonization of molten resin 40. In some examples, mold 30 may be maintained at relatively higher temperatures and/or higher pressures for relatively shorter durations of time. In some examples, mold 30 may be maintained at relatively lower temperatures and/or lower pressures for relatively longer durations of time.

In some examples, the carbonization of molten resin 40 may be performed in multiple stages. For example, porous carbon preform 31 and molten resin 40 may be partially carbonized initially at a relatively low pressure (e.g., below 5,000 psi) followed by an additional cycle of high pressure carbonization (e.g., above 5,000 psi). In other examples, porous carbon preform 31 and molten resin 40 may be partially carbonized initially at high pressure (e.g., above 5,000 psi) followed with an additional cycle of carbonization at a relatively low pressure (e.g., below 5,000 psi). Both examples, as well as others, are contemplated by this disclosure and use of the term carbonizing of the resin-infiltrated preform.

In some examples, infiltrating porous carbon preform 31 with molten resin 40 (10) and carbonizing molten resin 40 at high pressure (12) using inert gas 46 may be conducted using the same pressure vessel or mold 30. In other examples, steps (10) and (12) may be conducted using different pressure vessels, molds 30, or other systems.

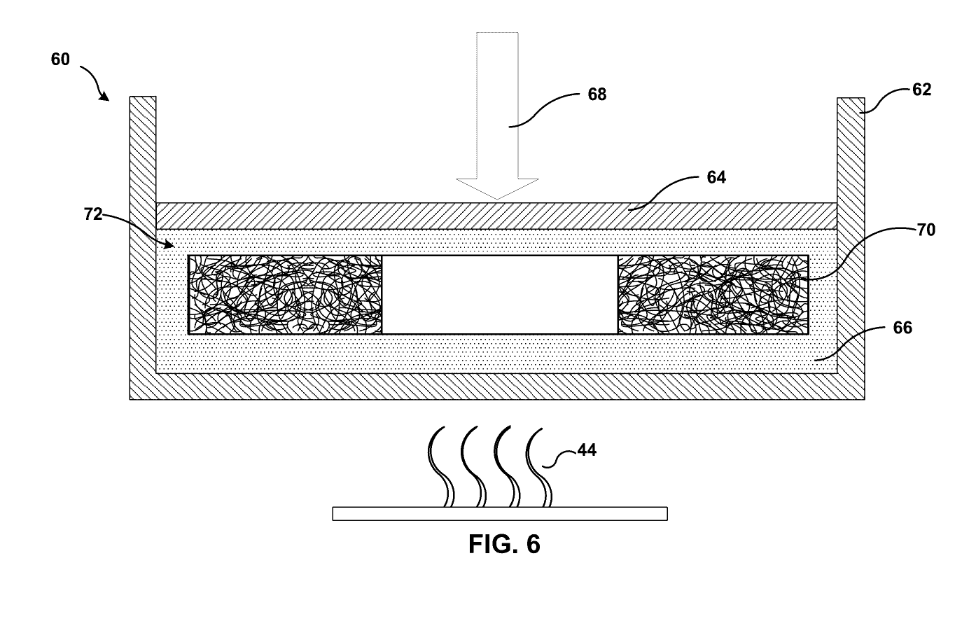

In some examples, carbonizing porous carbon preform 31 infiltrated with molten resin 40 at a high pressure (12) may be performed by applying isostatic pressure using a packing powder surrounding the resin-infiltrated preform. For example, FIG. 6 shows a lateral cross-sectional view of an example mold 60 containing a porous carbon preform that has been previously infiltrated with a resin (hereinafter “resin-infiltrated preform 70”), where the resin-infiltrated preform 70 substantially surrounded (e.g., surrounded or nearly surrounded) by a packing powder 66. Mold 60 may include an upper mold portion 64 and a lower mold portion 62, which define an inner mold chamber 72 for receiving and substantially enclosing (e.g., enclosing or nearly enclosing) resin-infiltrated preform 70 and packing powder 66. Once resin-infiltrated preform 70 and packing powder 66 are deposited in inner mold chamber 72, upper mold portion 64 may be lowered to contact packing powder 66. A high pressure 68 may then be applied to the mold 60, or at least upper mold portion 64. In some examples, the applied high pressure force 68 may be at least about 5,000 psi, at least about 10,000 psi, or at least about 15,000 psi. With high pressure force 68 applied to mold 60, or at least upper mold portion 64, packing powder 66 redistributes the high pressure forces substantially evenly (e.g., evenly or nearly evenly) around resin-infiltrated preform 70 establishing a high isostatic pressure.

The entire mold 60 may then be heated 44 to carbonize the resin-infiltrated preform 70. For example, mold 60 may be heated to above the carbonization temperature of molten resin 40, e.g. above 650° C., while maintaining the internal pressure of mold chamber 32 at or above about 5,000 psi. In some examples, the temperature may be increased at a rate of between about 25° C. and about 100° C. per hour to a target temperature of about 650° C. to about 900° C. with a target pressure of at least about 5,000 psi (e.g., about 10,000 to about 15,000 psi).

Once the target temperature and target pressure have been reached, the target temperature and target pressure are maintained sufficiently long to allow the infiltrated molten resin 40 to undergo carbonization (12). In some examples, the carbonization of molten resin 40 may be performed in a single or multiple stages. In some examples, mold 60 may be maintained at about 810° C. and about 10,000 psi to about 15,000 psi for about 12 hours to obtain sufficient carbonization of molten resin 40. In some examples, mold 60 may be maintained at about 900° C. at about 15,000 psi for 16 hours. In some examples, mold 60 may be maintained at relatively higher temperatures and/or higher pressures for relatively shorter durations of time. In some examples, mold 60 may be maintained at relatively lower temperatures and/or lower pressures for relatively longer durations of time.

In some examples, mold 60 may be formed of a rigid material configured to withstand high pressure 68 generated by a mechanical press such as a hydraulic press, hydraulic or ball screws driven by electric servo motors, or the like. In other examples, mold 60 may be formed of a semi-flexible material capable of withstanding the high temperatures of carbonization. In such configurations, the high pressure 68 may be established by pressurizing the outside of mold 60, for example by using a high pressure gas which may apply high pressure force 68 substantially evenly (e.g., evenly or nearly evenly) across the exterior of mold 60. The flexibility of mold 60 thereby compresses packing powder 60 and creates the high isostatic pressure used during carbonization.

Packing powder 66 may include any relatively fine grained material (e.g., 10 to 50 micron particles) capable of withstanding the high temperatures needed for carbonizing resin-infiltrated preform 70 at high pressure (12) without packing powder 66 undergoing physical transformations, e.g., melting or clumping, chemical reaction with materials used for mold 60 and resin-infiltrated preform 70, or both. In some examples, packing powder 66 may include, for example, activated carbon, carbon dust, graphite powder, fine grained silica or sand, or the like.

The resulting densified C—C composite 50 produced from the high pressure carbonization (12) techniques described above may possess an overall density of at least 1.9 g/cc in a few as one to four cycles of resin infiltration (10) and high pressure carbonization (12). In some examples, as achieving an overall density of at least 1.9 g/cc may require multiple densification cycles, steps (10) and (12) may be repeated (14) to obtain densified C—C composite 50 having an overall density of at least 1.9 g/cc.

In some examples, after carbonization of the resin-infiltrated preform at the high pressure (12) (e.g., after at least one of one or more carbonization steps (12)), the resulting densified C—C composite 50 may be heat treated. Heat treating densified C—C composite 50 may modify the crystal structure of the carbon atoms in densified C—C composite 50, which may result in modified mechanical, thermal, and chemical properties of the preform or composite respectively. Heat treatment may be conducted at a temperature in the range of 1400° C. to 2800° C., depending on the desired characteristics. Higher temperatures may result in a greater thermal conductivity, an increased elastic modulus of densified C—C composite 50, a greater degree of crystalline order of the carbon atoms in the resultant preform or composite, or the like. The degree of crystalline order may be determined using, for example, X-ray diffraction or Raman spectroscopy.

In some examples, densified C—C composite 50 may also be subjected to further machine processing to sculpt densified C—C composite 50 into the desired shape, such as a final brake disc shape. For example, between densification processing steps, the surfaces of densified C—C composite 50 may be ground down to partially expose the pores of the composite thereby allowing for additional densification cycles (10)-(12). Additionally or alternatively, once the final densified C—C composite 50 is obtained, densified C—C composite 50 may be ground using grinding equipment such as CNC (computer numerical control) machine to obtain a desired geometry. For example, densified C—C composite 50 may be ground in the shape of a densified C—C composite disc brake having a final thickness T (e.g., about 1.4 inches) having parallel and surfaces and defining an inside diameter ID and outside diameter OD of specified dimensions. Various examples have been described. These and other examples are within the scope of the following claims.

What is claimed is:

1. A method for making a carbon-carbon composite brake disc, comprising:
(i) infiltrating a porous carbon preform with a resin to form a resin-infiltrated preform, wherein the resin comprises at least one of an isotropic resin or a mesophase resin, and wherein the porous carbon preform is derived from:
a plurality of fabric sheets comprising non-woven fibers selected from the group consisting of oxidized polyacrylonitrile fibers, pitch fibers, or rayon fibers, wherein each fabric sheet of the plurality of fabric sheets has a basis weight in the range from about 1250 to about 3000 grams per square meter, and
needling fibers selected from the group consisting of oxidized polyacrylonitrile fibers, pitch fibers, or rayon fibers, wherein the needling fibers join together the plurality of fabric sheets;
(ii) carbonizing the resin-infiltrated preform at a pressure of at least about 5,000 psi to form a densified carbon-carbon composite disc brake; and
(iii) repeating steps (i)-(ii) until the densified carbon-carbon composite disc brake has a density of at least about 1.9 g/cc.

2. The method of claim 1, wherein the resin-infiltrated preform is not subjected to a resin-stabilization cycle prior to carbonizing the resin-infiltrated preform.

3. The method of claim 1, wherein infiltrating the porous carbon preform with the resin comprises using at least one of vacuum pressure infiltration or resin transfer molding to infiltrate the porous carbon preform with the resin.

4. The method of claim 1, wherein carbonizing the resin-infiltrated preform at the pressure of at least about 5,000 psi comprises:
depositing the resin-infiltrated preform in a mold;
substantially surrounding the resin-infiltrated preform with a packing powder;
compressing the resin-infiltrated preform and the packing powder under a pressure of at least 5,000 psi; and
heating the resin-infiltrated preform and the packing powder while under the pressure of at least 5,000 psi to above a carbonization temperature of the resin.

5. The method of claim 1, wherein the isotropic resin of the at least one of the isotropic resin or the mesophase resin comprises at least one of coal tar pitch or petroleum pitch.

6. The method of claim 1, wherein carbonizing the resin-infiltrated preform at the pressure of at least about 5,000 psi comprises subjecting the resin-infiltrated preform to the pressure of at least about 5,000 psi and a temperature above about 650° C. to allow at least some of the resin to carbonize.

7. The method of claim 1, wherein the porous carbon preform and the densified carbon-carbon composite disc brake are not subjected to chemical vapor deposition or chemical vapor infiltration.

8. A method for making a carbon-carbon composite brake disc, comprising:
(i) placing a porous carbon preform in a mold, wherein the porous carbon preform is derived from:
a plurality of fabric sheets comprising non-woven fibers selected from the group consisting of oxidized polyacrylonitrile fibers, pitch fibers, or rayon fibers, wherein each fabric sheet of the plurality of fabric sheets has a basis weight in the range from about 1250 to about 3000 grams per square meter, and
needling fibers selected from the group consisting of oxidized polyacrylonitrile fibers, pitch fibers, or rayon fibers, wherein the needling fibers join together the plurality of fabric sheets;
(ii) infiltrating, in the mold, the porous carbon preform with a resin using a first pressure of at least about 50 psi to form a resin-infiltrated preform, wherein the resin comprises at least one of an isotropic resin or a mesophase resin;
(iii) carbonizing the resin-infiltrated preform under a second high pressure of at least about 5,000 psi, to form a densified carbon-carbon composite disc brake.

9. The method of claim 8, wherein the resin-infiltrated preform is not subjected to a resin-stabilization cycle prior to carbonizing the resin-infiltrated preform.

10. The method of claim 8, wherein carbonizing the resin-infiltrated preform is conducted in the mold.

11. The method of claim 8, further comprising repeating steps (i)-(iii) until the densified carbon-carbon composite disc brake has a final density of at least about 1.9 g/cc.

12. The method of claim 8, wherein carbonizing the resin-infiltrated preform under the second high pressure of at least about 5,000 psi, comprises:
introducing a gas into the mold containing the resin-infiltrated preform to establish the second high pressure.

13. The method of claim 8, wherein the isotropic resin of the at least one of the isotropic resin or the mesophase resin comprises at least one of coal tar pitch or petroleum pitch.

14. The method of claim 8, wherein carbonizing the resin-infiltrated preform under the second high pressure comprises subjecting the resin-infiltrated preform to the second high pressure and a temperature above about 650° C. to allow the resin to at least partially carbonize.

15. The method of claim 8, wherein the porous carbon preform has not undergone a cycle of a chemical vapor deposition or a chemical vapor infiltration.

16. An assembly for making a carbon-carbon composite disc brake comprising:
a mold;
a resin-infiltrated preform in the shape of a disc brake comprising:
a non-stabilized resin comprising at least one of an isotropic resin or a mesophase resin, and
a porous carbon preform derived from:
a plurality of fabric sheets comprising non-woven fibers selected from the group consisting of oxidized polyacrylonitrile fibers, pitch fibers, or rayon fibers, wherein each fabric sheet of the plurality of fabric sheets has a basis weight in the range from about 1250 to about 3000 grams per square meter, and
needling fibers selected from the group consisting of oxidized polyacrylonitrile fibers, pitch fibers, or rayon fibers, wherein the needling fibers join together the plurality of fabric sheets, wherein the resin-infiltrated preform is disposed in the mold;
a pressure source configured to apply a pressure of at least about 5,000 psi to the resin-infiltrated preform deposited in the mold; and
a heat source configured to heat the mold and the resin-infiltrated preform to a temperature sufficient to carbonize the non-stabilized resin.

17. The assembly of claim 16, wherein the heat source is configured to heat the mold to at least 650 degrees Celsius.

18. The assembly of claim 16, wherein the isotropic resin of the at least one of the isotropic resin or the mesophase resin comprises at least one of coal tar pitch or petroleum pitch.

19. The assembly of claim 16, wherein the pressure source is at least one of a high pressure gas or a mechanical press.

20. The assembly of claim 16, wherein the porous carbon preform has not undergone a cycle of a chemical vapor deposition or a chemical vapor infiltration.
